(19) United States
(12) Patent Application Publication
(10) Pub. No.: US 2026/0107352 A1
(43) Pub. Date: Apr. 16, 2026

(54) MICROWAVE OVEN WITH AIR-FRY FUNCTION AND MICROWAVE OVEN CONTROL METHOD

(71) Applicant: Guangzhou Xin'an Trading Co., Ltd., Guangzhou (CN)

(72) Inventors: Huixiong Wu, Guangzhou (CN); Lei Peng, Guangzhou (CN); Chunyu Tang, Guangzhou (CN)

(21) Appl. No.: 18/981,709

(22) Filed: Dec. 16, 2024

(30) Foreign Application Priority Data
Oct. 16, 2024 (CN) 202411445882.2
Oct. 23, 2024 (CN) 202411485584.6

(51) Int. Cl. H05B 6/64; A23L 5/10; A47J 37/06; F24C 15/32; H05B 6/68

(52) U.S. Cl. CPC H05B 6/6473; A23L 5/15; A23L 5/17; A47J 37/0641; F24C 15/322; H05B 6/68

(57) ABSTRACT

The present disclosure discloses a microwave oven with an air-fry function and a microwave oven control method. The microwave oven with an air-fry function includes an oven body, a microwave component, an air-fry component, and a container, where a cooking chamber is disposed in the oven body, the air-fry component is connected to the oven body, the container is placed on a position that is in the cooking chamber and close to the air-fry component, and hot air generated by the air-fry component enters the oven body to generate a heating effect on the food through cooperation between the air-fry component and the microwave component. According to the present disclosure, food heating time can be shortened, the food can be quickly cooked thoroughly, and cooking efficiency is improved.

### CROSS REFERENCE TO RELATED APPLICATIONS

The present application claims the benefit of Chinese Patent Application Nos. 2024114458822 filed on Oct. 16, 2024 and 2024114855846 filed on Oct. 23, 2024. All the above are hereby incorporated by reference in their entirety.

### TECHNICAL FIELD

The present disclosure relates to the technical field of household appliances, and in particular, relates to a microwave oven with an air-fry function and a microwave oven control method.

### BACKGROUND

With rapid development of modern kitchen appliances, microwave ovens and air fryers have become indispensable cooking tools for many families. With a microwave cooking function, the microwave oven is mainly configured to heat food from inside to outside, and consequently, it takes a long time for the microwave oven to heat food with a large volume. However, the air fryer is mainly configured to cook food from outside to inside by using a high-speed hot air circulation technology. For food with a large volume or rich fibrous tissues therein, it is hard for the air fryer to thoroughly heat, and consequently, the inside of the food is cooked well but the outer skin is usually burnt.

To integrate the advantages of the microwave oven and the air fryer, a microwave oven with an air-fry function appears on the market, namely, an air-fry microwave oven. The air-fry microwave oven is designed to quickly heat and roast food by combining the features of the air fryer and the microwave oven. However, an existing air-fry microwave oven cannot quickly cook food thoroughly, is long in time for heating food, and is low in cooking efficiency due to an improper layout of internal modules and an improper control method. For example, an excessively long hot air circulation line of an air-fry module, and poor cooperation between a microwave module and the air-fry module.

### SUMMARY

To resolve the technical problems in the prior art, the present disclosure provides a microwave oven with an air-fry function, to shorten time for heating food, quickly cook food thoroughly, and improve cooking efficiency.

To resolve the technical problems, the present disclosure provides a microwave oven with an air-fry function, including an oven body, a microwave component, and a container, where a cooking chamber is disposed in the oven body, the container is configured to place food, the container is placed in the cooking chamber, the microwave component is connected to the oven body, and microwaves generated by the microwave oven enter the oven body to heat the food.

The microwave oven with an air-fry function further includes an air-fry component, where the air-fry component is connected to the oven body, the container is placed on a position that is in the cooking chamber and close to the air-fry component, and hot air generated by the air-fry component enters the oven body to heat the food through cooperation between the air-fry component and the microwave component.

As an improvement of the technical solution, the cooking chamber includes a first placement area, where the first placement area is positioned on an upper portion of the cooking chamber and is positioned below the air-fry component, and the container is placed in the first placement area.

As an improvement of the technical solution, a top plate is disposed on a top of the cooking chamber, the air-fry component is disposed above the top plate, the container is placed below the top plate, a containing groove is provided in the container, and a groove opening of the containing groove faces toward the top plate.

As an improvement of the technical solution, a plurality of air holes are provided on the top plate, the plurality of air holes are distributed corresponding to the groove opening of the containing groove, and hot air generated by the air-fry component passes through the air holes to be in contact with the food in the container.

As an improvement of the technical solution, a downward protrusion is disposed on the top plate, the downward protrusion is protruded downward, the air holes are provided on the downward protrusion, and a distance between a bottom surface of the downward protrusion and a top of the containing groove is within a range of 1 mm to 35 mm.

As an improvement of the technical solution, the microwave component includes a microwave release hole, where the microwave release hole is positioned on a side wall or a bottom of the cooking chamber, the microwaves generated by the microwave component penetrate at least one wall surface of the container through the microwave release hole to reach the inside of the food.

As an improvement of the technical solution, the container is made of at least one of a ceramic material, a plastic material, or a glass material through which the microwaves can penetrate.

As an improvement of the technical solution, a through hole is provided on at least one wall surface of the container, a wave-transmitting plate is mounted in the through hole, and the wave-transmitting plate is made of at least one of a ceramic material, a plastic material, or a glass material through which the microwaves can penetrate.

The present disclosure further provides a microwave oven control method for controlling the above microwave oven with an air-fry function, including the following steps:
heating food by using a microwave mode and/or an air-fry mode; and
alternately using the microwave mode and the air-fry mode at a cycle stage for heating the food.

As an improvement of the technical solution, the microwave oven control method further includes: before heating the food, preheating the cooking chamber by using the air-fry mode.

As an improvement of the technical solution, the step of preheating the cooking chamber by using the air-fry mode includes:
continuously heating the cooking chamber by using the air-fry mode, continuously detecting a temperature in the cooking chamber, and stopping the air-fry mode when the temperature in the cooking chamber reaches a preset temperature.

As an improvement of the technical solution, the step of preheating the cooking chamber by using the air-fry mode further includes:
after preheating, putting, by a user, the container into the first placement area, and then starting to heat the food or directly entering the cycle stage.

As an improvement of the technical solution, the step of heating food includes:
heating the food by using the microwave mode, and then entering the cycle stage; where
microwaves generated by the microwave component penetrate a bottom and/or a side part of the container to reach the inside of the food.

As an improvement of the technical solution, the step of heating food by using a microwave mode includes:
heating the food by the microwave component at a rated power, and entering the cycle stage after heating time reaches first preset duration.

As an improvement of the technical solution, at the cycle stage for heating the food, the microwave oven control method further includes the following step:
stopping the microwave mode and the air-fry mode at the cycle stage when total heating time of the microwave mode and the air-fry mode reaches second preset duration.

As an improvement of the technical solution, at the cycle stage for heating the food, the microwave oven control method further includes the following step:
setting a ratio of the first preset duration to the second preset duration to be within a range of 1/10 to 5/1.

As an improvement of the technical solution, the step of alternately using the microwave mode and the air-fry mode includes:
making use time of the microwave mode be not greater than use time of the air-fry mode.

As an improvement of the technical solution, the step of alternately using the microwave mode and the air-fry mode further includes:
setting a ratio of the use time of the microwave mode to the use time of the air-fry mode to be within a range of 1/7 to 6/7.

The implementation of the present disclosure has the following beneficial effects:

The microwave oven with an air-fry function in the present disclosure has the oven body, the microwave component, the air-fry component, and the container, where the microwave component and the air-fry component can respectively implement a heating function and an air heating function, and the container can be placed on a position that is in the cooking chamber and close to the air-fry component, so that both the food and the container are close to the air-fry component. In this way, when the food is heated, hot air generated by the air-fry component can quickly reach a surface of the food as the food is close to the air-fry component. In addition, the container and the cooking chamber can form relatively sealed space as the container is close to the air-fry component, so that hot air has high heating efficiency in the relatively sealed space, and heat is ensured to be concentrated on heating the food, thereby improving heating efficiency of the air-fry component, quickly heating the food thoroughly through cooperation between the air-fry component and the microwave component, shortening heating time, quickly cooking the food thoroughly, and improving cooking efficiency.

### BRIEF DESCRIPTION OF THE DRAWINGS

FIG. 1 is a schematic diagram of a structure of a microwave oven with an air-fry function according to the present disclosure;

FIG. 2 is a schematic diagram of a sectional structure of a microwave oven with an air-fry function according to the present disclosure;

FIG. 3 is a partial enlarged view of A in FIG. 2;

FIG. 4 is a structural diagram of a structure of a container according to the present disclosure;

FIG. 5 is a schematic flowchart of a microwave oven control method according to a first embodiment of the present disclosure; and

FIG. 6 is a schematic flowchart of a microwave oven control method according to a second embodiment of the present disclosure.

### DETAILED DESCRIPTION

In order to make the objectives, technical solutions, and advantages of the present disclosure clearer, the present disclosure will be further described in detail below with reference to the accompanying drawings. It should be noted that orientation terms such as “upper”, “lower”, “left”, “right”, “front”, “rear”, “inner”, and “outer” that appear or are about to appear in the present disclosure are only based on the accompanying drawings of the present disclosure, and do not specifically limit the present disclosure.

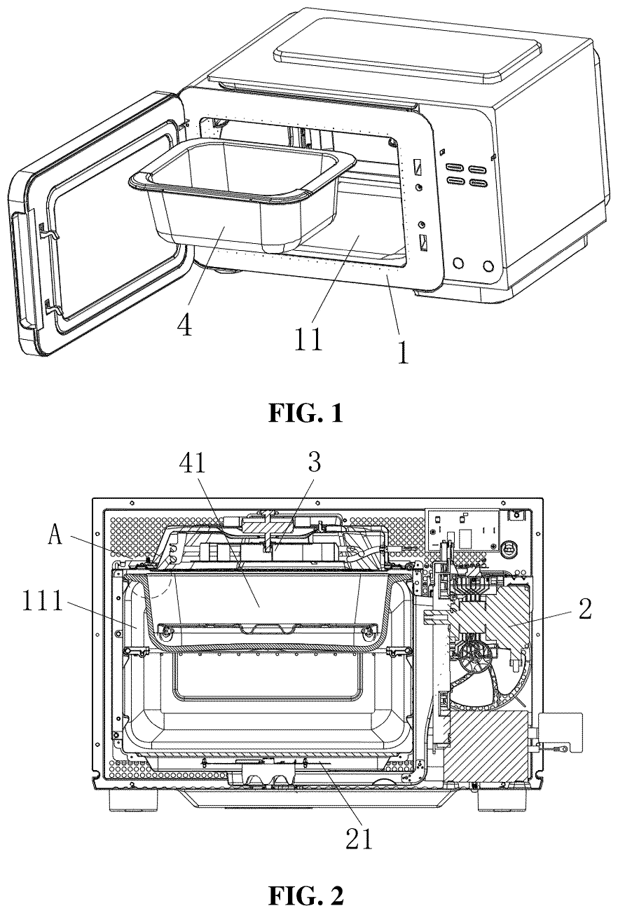

Refer to FIG. 1 and FIG. 2. An embodiment of the present disclosure discloses a microwave oven with an air-fry function, including an oven body 1, a microwave component 2, and a container 4. A cooking chamber 11 is disposed in the oven body 1, the container is configured to place food 4, and the container 4 is placed in the cooking chamber 11, making the food be placed in the cooking chamber 11 for cooking. The microwave component 2 is connected to the oven body 1, the microwave component 2 is configured to generate microwaves, and the microwaves generated by the microwave oven 2 enter the oven body 1 to heat the food. The container 4 is preferably made of a transparent material or a metal material with a hollow-out hole, making the microwaves generated by the microwave component 2 penetrate the container 4 to reach the inside of the food.

To improve heating efficiency, the microwave oven with an air-fry function further includes an air-fry component 3. The air-fry component 3 is configured to generate hot air to heat the food. The air-fry component 3 is connected to the oven body 1, so that the generated hot air enters the cooking chamber 11. To improve heating efficiency of the air-fry component 3, the container 4 is placed on a position that is in the cooking chamber 11 and close to the air-fry component 3, so that both the container 4 and the food in the container 4 are close to the air-fry component 3. In this case, the hot air generated by the air-fry component 3 can quickly reach a surface of the food, space between the container 4 and the air-fry component 3 is smaller than space in the cooking chamber 11, the container 4 and the cooking chamber 11 can form relatively sealed space, the hot air can heat the food repeatedly in the relatively sealed space, and heat is ensured to be concentrated on heating the food, and therefore, heating efficiency is high. The hot air generated by the air-fry component 3 enters the oven body 1 to heat the food through cooperation between the air-fry component and the microwave oven component 2, and therefore, the food can be cooked thoroughly more quickly through cooperation between the microwave component 2 and the air-fry component 3, and time for heating the food is shortened.

The embodiments of the present disclosure have the following beneficial effects:

The microwave oven with an air-fry function in the present disclosure has the oven body 1, the microwave component 2, the air-fry component 3, and the container 4. The microwave component 2 and the air-fry component 3 can respectively implement a heating function and an air heating function, and the container 4 is placed on a position that is in the cooking chamber 11 and close to the air-fry component 3, so that both the food and the container 4 are close to the air-fry component 3. In this way, when the food is heated, hot air generated by the air-fry component 3 can quickly reach a surface of the food as the food is close to the air-fry component 3. In addition, the container 4 and the cooking chamber 11 can form relatively sealed space as the container 4 is close to the air-fry component 3, so that hot air has high heating efficiency in the relatively sealed space, and heat is ensured to be concentrated on heating the food, thereby improving heating efficiency of the air-fry component 3, quickly heating the food thoroughly through cooperation between the air-fry component 3 and the microwave component 2, shortening heating time, quickly cooking the food thoroughly, and improving cooking efficiency.

Specifically, the cooking chamber 11 includes a first placement area 111, where the first placement area 111 is positioned on an upper portion of the cooking chamber 11 and is positioned below the air-fry component 3, the first placement area 111 is positioned on a position that is in the cooking chamber 11 and close to the air-fry component 3, the first placement area 111 is provided with a corresponding clamping structure, and the container 4 is placed in the first placement area 111, so that both the container 4 and the food in the container 4 are close to the air-fry component 3.

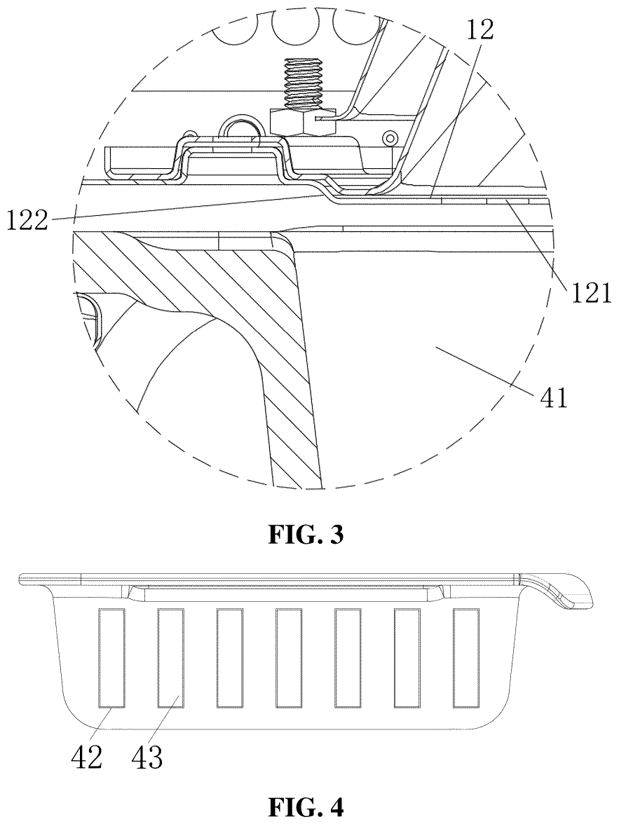

Refer to FIG. 3. A top plate 12 is disposed on a top of the cooking chamber 11, and the top plate 12 is an upper wall surface of the cooking chamber 11, where the air-fry component 3 is disposed above the top plate 12, the air-fry component 3 can communicate with space below the top plate 12, the container 4 is placed below the top plate 12, a containing groove 41 is provided in the container 4, and a groove opening of the containing groove 41 faces toward the top plate 12. In use, hot air generated by the air-fry component 3 enters the containing groove 41 through the top plate 12 for heating the food in the containing groove 41. The groove opening of the containing groove 41 faces toward the top plate 12 and is close to the air-fry component 3, so that the containing groove 41 and the top plate 12 form relatively sealed space. The space is smaller than the cooking chamber 11, so that the hot air generated by the air-fry component 3 is mainly circulated in small sealed space between the containing groove 41 and the top plate 12. The food occupies most of the small sealed space, so that the food can be repeatedly heated through the hot air. Hot air generated by a conventional air-fry component 3 is circulated in the entire cooking chamber 11, and the food only occupies a small part of the cooking chamber 11, so that the hot air generated by the air-fry component 3 cannot reach a surface of the food the first time. In addition, the hot air is circulated in large space of the cooking chamber 11, so that heat loss is large, and central heating cannot be achieved. Therefore, compared with a conventional air-fry microwave oven, the microwave oven with an air-fry function in the present disclosure has the advantages of a high heating speed and high heating efficiency.

To make the hot air enter the containing groove 41, a plurality of air holes 121 are provided on the top plate 12, the plurality of air holes 121 are distributed corresponding to the groove opening of the containing groove 41, and the hot air generated by the air-fry component 3 passes through the air holes 121 to be in contact with the food in the container 4.

To further make the hot air enter the containing groove 41 and compress the space between the containing groove 41 and the top plate 12 to a greatest extent, the top plate 12 is provided with a downward protrusion 122, where the downward protrusion 122 is projected downward, the air holes 121 are provided on the downward protrusion 122, and the downward protrusion 122 can form a good sealing effect with an opening of the containing groove 41, so that the hot air can be blown out from a lower position to the greatest extent, space in the container 41 is further compressed, and heating is more central. In this embodiment of the present disclosure, a distance between a bottom surface of the downward protrusion 122 and the top of the containing groove 41 is within a range of 1 mm to 35 mm, is preferably within a range of 1 mm to 10 mm, so that a good sealed state can be formed.

Refer to FIG. 2, the microwave component 2 includes a microwave release hole 21, where the microwave release hole 21 is positioned on a side wall or a bottom of the cooking chamber 11, the microwaves generated by the microwave component 2 can be guided to the microwave release hole 21, and the microwave release hole 21 communicates with the cooking chamber 11, and therefore, the microwaves can be released from the microwave release hole 21. In this embodiment, the microwave release hole 21 is provided on the bottom of the cooking chamber 11. In another embodiment, the microwave release hole 21 is provided on the side wall of the cooking chamber 11. The microwaves generated by the microwave component 2 penetrate at least one wall surface of the container 4 through the microwave release hole 21 to reach the inside of the food, so as to heat the food.

Refer to FIG. 4, in an embodiment, to make the microwaves heat the food, the container 4 is made of at least one of a transparent ceramic material, a plastic material, and a glass material through which the microwaves can penetrate, and may be selectively made of a high-temperature-resistant glass material, ceramic material, food-level plastic material, or the like. The plastic may be heat-resistant plastic such as polypropylene or polycarbonate or polyethylene. Therefore, the microwaves can penetrate the container 4 to reach the inside of the food. In another embodiment, at least one wall surface of the container 4 is provided with a through hole 42, a wave-transmitting plate 43 is mounted in the through hole 42, the container 4 may be made of a metal material, and heat conduction and strength of the metal material are good. Through the through hole 42, the microwaves enter the container 4. To make the microwaves enter the container, the wave-transmission board 43 is made of at least one of transparent ceramic material, a plastic material, and a glass material through which the microwaves can penetrate, and may be selectively made of a high-temperature-resistant glass material, ceramic material, food-level plastic material, or the like. The plastic may be heat-resistant plastic such as polypropylene or polycarbonate or polyethylene.

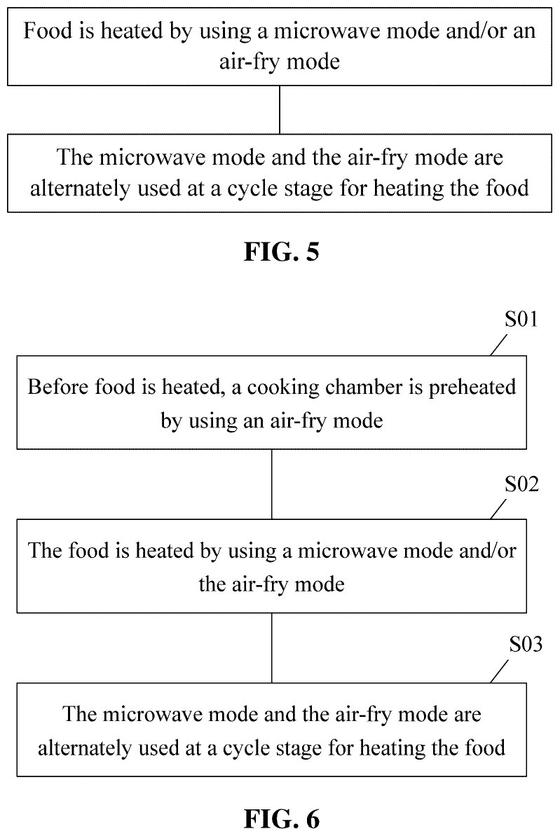

Refer to FIG. 5. An embodiment of the present invention further discloses a microwave oven control method for controlling the microwave oven with an air-fry function. In a first embodiment, the microwave oven control method includes the following steps.

Food is heated by using a microwave mode and/or an air-fry mode.

The microwave mode and the air-fry mode are alternately used at a cycle stage for heating the food.

The container 4 is placed on a position that is in the cooking chamber 11 and close to the air-fry component 3, the container 4 and food in the container 4 are close to the air-fry component 3, and a containing groove 41 of the container 4 and the top plate 12 form relatively sealed space, so that hot air generated in the air-fry component 3 is mainly circulated in small sealed space between the containing groove 41 and the top plate 12. The food occupies most of the sealed small space, so that the food can be repeatedly heated through the hot air. In this process, the air-fry mode intermittently cooperates with the microwave mode to heat the food, so that a higher heating speed and higher heating efficiency can be achieved.

Refer to FIG. 6. An embodiment of the present invention further discloses a microwave oven control method for controlling the above microwave oven with an air-fry function. In a second embodiment, the microwave oven control method includes the following steps.

In step S01, before food is heated, the cooking chamber 11 is preheated by using an air-fry mode.

In step S02, the food is heated by using a microwave mode and/or the air-fry mode.

In step S03, the microwave mode and the air-fry mode are alternately used at a cycle stage for heating the food.

It should be noted that, before the food is heated, the cooking chamber 11 is preheated by using the air-fry mode, so that each part of the cooking chamber 11 reaches a high temperature, and each part of the cooking chamber 11 does not additionally absorb heat when the food is heated subsequently, ensuring heat to be concentrated in the containing groove 41 for heating the food.

When the food is heated, the food is heated by using the microwave mode, the air-fry mode or a combination of the microwave mode and the air-fry mode. When the food is heated by using the microwave mode, the inside of the food is heated through penetrability of the microwaves, to ensure that the inside of the food is cooked thoroughly. When the food is heated, the food can be heated by alternately using the microwave mode and the air-fry mode, to ensure the inside and an outer surface of the food to be heated at different time, and separately heat the food from the inside to the outside and from the outside to the inside in cycles.

The step that a cooking chamber 11 is preheated by using the air-fry mode includes the following step:

The cooking chamber 11 is continuously heated by using the air-fry mode, a temperature in the cooking chamber 11 is continuously detected, and the air-fry mode is stopped when the temperature in the cooking chamber 11 reaches a preset temperature.

In the preheating process, the preheating process needs to be controlled. When the temperature in the cooking chamber 11 reaches the preset temperature, the air-fry mode is stopped. In this case, the temperature at each part inside the cooking chamber 11 is close to a temperature to be heated to subsequently, so that an outer surface of the food can be in a high-temperature environment when the food is heated.

The step that a cooking chamber 11 is preheated by using the air-fry mode includes the following step:

After preheating is completed, the container 4 is placed into the first placement area 111 by a user, and then the food is started to be heated or the cycle stage is directly entered.

After the temperature in the cooking chamber 11 is close to the temperature to be heated to, the user opens an oven door to place the container 4 filled with the food into the cooking chamber 11, and then closes the oven door. Under system control, the food is heated by using the microwave mode and/or the air-fry mode. The container 4 is placed into the first placement area 111, the first placement area 111 is positioned on a position that is in the cooking chamber 11 and close to the air-fry component 3, and the containing groove 41 and a top plate 12 form relatively sealed space. During subsequent heating, hot air generated in the air-fry component 3 is mainly circulated in small sealed space between the containing groove 41 and the top plate 12. The food occupies most of the sealed small space, so that the food can be repeatedly heated through the hot air, and therefore, a heating speed is high. At an initial heating stage, the food is heated by using the microwave mode and/or the air-fry mode. In some embodiments, the cycle stage can be directly entered, and the food is heated by alternately using the microwave mode and the air-fry mode.

The step that food is heated includes the following step.

The food is heated by using the microwave mode, and then the cycle stage is entered.

Microwaves generated by the microwave component 2 penetrate a bottom and/or a side part of the container 4 to reach the inside of the food.

When the food is heated, the food is heated by using the microwave mode, which is an initial heating process. In the initial heating process, the microwaves can quickly penetrate the inside of the food, so that the food is quickly heated. This step is especially important in the initial heating stage, so that an overall temperature of the food can be quickly increased. This can ensure the inside of the food to be quickly cooked thoroughly, and also can quickly increase the inside temperature of the food, to lay a good foundation for the subsequent cycle stage.

Before heating is performed, the cooking chamber 11 is preheated through the air-fry component 3. After the food is placed into the cooking chamber 11, the outer surface of the food is in a high-temperature environment, so that the outer surface of the food achieves a microwave heating effect from the outside to the inside while the microwave component 2 is started to heat the food. The microwave heating effect is different from a direct heating effect of the air-fry component 3. When the food is directly heated by the air-fry component 3, water on the surface of the food is quicky air-dried, and consequently, heating efficiency is affected as subsequent microwave heating is not easily acted on the surface of the food. However, during microwave heating, the water on the surface of the food is not quickly air-dried while heat is transferred on the surface of the food. Therefore, when the food is subsequently heated by using the microwave mode, a microwave heating temperature can be simultaneously acted to the surface and the inside during microwave heating, so that the outer surface of the food is finally crispy, but not dry while being quickly heated. If the food is heated by using the air-fry mode, the surface of the food is easily air-dried, affecting a synergy effect of subsequent microwave heating.

The microwave component 2 includes a microwave release hole 21, and the microwave release hole 21 is provided on a side wall or bottom of the cooking chamber 11. Microwaves generated by the microwave component 2 can be guided to the microwave release hole 21, and are released through the microwave release hole 21, to reach the inside of the food after passing through the bottom and/or side part of the container 4.

In the cycle stage, on the basis of microwave heating, the surface of the food is further heated by using the air-fry mode through high-speed hot air circulation, to form a crisp surface and retain juice of the food. In the microwave mode, the food is heated from the inside to the outside. In the air-fry mode, the food is roasted from the outside to the inside, and the microwave mode and the air-fry mode are alternately used in a heating cycle, so that advantages of the microwave mode and the air-fry mode can be sufficiently utilized, heating efficiency is improved, and a heating speed is increased. In addition, the heating cycle in which the microwave mode and the air-fry mode are alternately used helps heating the food uniformly, and avoids a case in which the food is locally overheated or undercooked, so that a mouthfeel of the cooked food is crisper, and more nutrient components are kept.

The step that the food is heated by using the microwave mode includes the following step:

The food is heated by the microwave component 2 at a rated power, and the cycle stage is entered after heating time reaches first preset duration.

Duration for initial heating is the first preset duration, and the duration can be preset according to different kinds of food. In the initial heating process, the microwave component 2 is run at a rated power, that is, the microwave component 2 is run at a largest gear. A high heating power is combined with the microwave heating effect generated in the initial heating process, so that the inside and the outside of the food are heated with maximum efficiency before the water on the surface of the food is air-dried. The microwave heating temperature can be simultaneously acted to the surface and the side, so that the outer surface of the food is finally crispy, but not dry while being quickly heated. Therefore, the initial heating process and the preheating process generate a synergy effect.

Further, in some products capable of controlling a power or frequency of the air-fry mode, the air-fry mode and the microwave mode can be cooperated for further heating, where the step that the food is heated by using the microwave mode includes the following step:

After the food is heated by the microwave component 2 for a period of time at the rated power, the air-fry component 3 is started to perform auxiliary heating on the food, where the air-fry component 3 is run in an energy-saving mode.

The energy-saving mode of the air-fry component 3 is a low-gear mode. In this mode, hot air generated by the air-fry component 3 has a low air quantity, and is mainly used to disturb air. In this process, the micro-heating effect on the surface of the food is kept, so that the microwave component 2 is assisted in performing synergetic heating.

At the cycle stage for heating the food, the following step is further included, to obtain good balance between quick heating and mouthfeel improvement of the food by controlling heating duration of different modes.

The microwave mode and the air-fry mode are stopped at the cycle stage when total heating time of the microwave mode and the air-fry mode reaches second preset duration.

The entire heating process includes an initial heating stage (namely, a stage at which the food is heated by using the microwave mode), and a cycle heating stage (namely, a stage at which the microwave mode and the air-fry mode are alternately used). Duration of the initial heating stage is the first preset duration, and duration of the cycle heating stage is the second preset duration, where the duration of the two stages may be different. In some embodiments, the first preset duration is less than the second preset duration. The initial heating stage occupies a small part of the entire heating process. Within a small period of time of the initial heating stage, the inside and the outside of the food can be quickly heated by using the microwave mode in a case in which the water on the surface of the food is not air-dried, so that the surface of the food is not too dry. Then, the cycle heating stage is started to quickly heat the food. In some other embodiments, for food with much water on a surface, the first preset duration may be greater than the second preset duration, so that the surface of the food is not quickly and easily air-dried. In the subsequent cycle heating stage, the high-heat microwave mode or air-fry mode can be used to quickly heat the food.

In embodiments of the present disclosure, a ratio of the first preset duration to the second preset duration is within a range of 1/10 to 5/1. When the ratio of the first preset duration to the second preset duration is less than 1/10, initial heating time is insufficient, so that it is difficult to heat the inside and the outside of the food within duration in which the water on the surface of the food is not air-dried, that is, the effect of quickly heating cannot be reached, and the mouthfeel of the food cannot be improved. When the ratio of the first preset duration to the second preset duration is greater than 5/1, the surface of the food is easily air-dried and the mouthfeel of the food is affected as the initial heating stage is excessively long. In addition, the heating time is prolonged as a whole, and a high overall heating speed cannot be obtained.

The step that the microwave mode and the air-fry mode are alternately used includes the following step:

Use time of the microwave mode is set to be not greater than use time of the air-fry mode.

In the alternate heating cycle, microwave heating focuses on quick penetration and overall temperature rise, and air-fry heating focuses on surface roasting and embrittling. Therefore, in the alternate heating cycle, the microwave mode is mainly used to quickly increase the inner temperature of the food, and the air-fry mode is used to further strengthen and optimize the heating effect. In this case, running time of the microwave mode does not need to be excessively long, to avoid excessive heating and water loss. In another aspect, although microwave heating is quick, long-time running of the microwave heating may lead to energy efficiency drop and overheating of the food. In the air-fry mode, energy efficiency can be optimized by adjusting a temperature and a circulation air speed. As the container 4 and the food in the container 4 are close to the air-fry component 3, the air-fry mode has high heating efficiency on the food. The food can be ensured to obtain high heating efficiency in a roasting process by ensuring use time of the air-fry mode, and a proper temperature and humidity can be kept.

In embodiments of the prevent disclosure, the step that the microwave mode and the air-fry mode are alternately used further includes the following step:

A ratio of the use time of the microwave mode to the use time of the air-fry mode is set to be within a range of 1/7 to 6/7. When the ratio of the use time of the microwave mode to the use time of the air-fry mode is less than 1/7, a poor mouthfeel that the food is excessively dry is caused by excessively long use time of the air-fry mode. When the ratio of the use time of the microwave mode to the use time of the air-fry mode is greater than 6/7, energy consumption increase caused by excessively long use time of the microwave mode is caused. This is unhelpful to energy conservation and emission reduction.

The above descriptions are merely preferred implementations of the present disclosure. It should be noted that a person of ordinary skill in the art may further make several improvements and modifications without departing from the principle of the present disclosure, but such improvements and modifications should be deemed as falling within the protection scope of the present disclosure.

1. A microwave oven with an air-fry function, comprising an oven body, a microwave component, and a container, wherein a cooking chamber is disposed in the oven body, the container is configured to place food, the container is placed in the cooking chamber, the microwave component is connected to the oven body, microwaves generated by the microwave component enter the oven to heat the food; and
the microwave oven with an air-fry function further comprises an air-fry component, wherein the air-fry component is connected to the oven body, the container is placed on a position that is in the cooking chamber and close to the air-fry component, and hot air generated by the air-fry component enters the oven body to heat the food through cooperation between the air-fry component and the microwave component.

2. The microwave oven with an air-fry function according to claim 1, wherein the cooking chamber comprises a first placement area, the first placement area is positioned on an upper portion of the cooking chamber and is positioned below the air-fry component, and the container is placed in the first placement area.

3. The microwave oven with an air-fry function according to claim 1, wherein a top plate is disposed on a top of the cooking chamber, the air-fry component is disposed above the top plate, the container is placed below the top plate, a containing groove is provided in the container, and a groove opening of the containing groove faces toward the top plate.

4. The microwave oven with an air-fry function according to claim 3, wherein a plurality of air holes are provided on the top plate, the plurality of air holes are distributed corresponding to the groove opening of the containing groove, and the hot air generated by the air-fry component passes through the air holes to be in contact with the food in the container.

5. The microwave oven with an air-fry function according to claim 4, wherein a downward protrusion is disposed on the top plate, the downward protrusion is protruded downward, the air holes are provided on the downward protrusion, and a distance between a bottom surface of the downward protrusion and a top of the containing groove is within a range of 1 mm to 35 mm.

6. The microwave oven with an air-fry function according to claim 1, wherein the microwave component comprises a microwave release hole, the microwave release hole is positioned on a side wall or a bottom of the cooking chamber, and the microwaves generated by the microwave component penetrate at least one wall surface of the container through the microwave release hole to reach the inside of the food.

7. The microwave oven with an air-fry function according to claim 6, wherein the container is made of at least one of a ceramic material, a plastic material, or a glass material through which the microwaves are capable of penetrating.

8. The microwave oven with an air-fry function according to claim 6, wherein a through hole is provided on at least one wall surface of the container, a wave-transmitting plate is mounted in the through hole, and the wave-transmitting plate is made of at least one of a ceramic material, a plastic material, or a glass material through which the microwaves are capable of penetrating.

9. A microwave oven control method for controlling the microwave oven with an air-fry function according to claim 1, comprising the following steps:
heating food by using a microwave mode and/or an air-fry mode; and
alternately using the microwave mode and the air-fry mode at a cycle stage for heating the food.

10. The microwave oven control method according to claim 9, comprising the following step:
before heating the food, preheating the cooking chamber by using the air-fry mode.

11. The microwave oven control method according to claim 10, where the step of preheating the cooking chamber by using the air-fry mode comprises:
continuously heating the cooking chamber by using the air-fry mode, continuously detecting a temperature in the cooking chamber, and stopping the air-fry mode when the temperature in the cooking chamber reaches a preset temperature.

12. The microwave oven control method according to claim 10, wherein the step of preheating the cooking chamber by using the air-fry mode further comprises:
after preheating, putting, by a user, the container into the first placement area, and then starting to heat the food or directly entering the cycle stage.

13. The microwave oven control method according to claim 10, wherein the step of heating food comprises:
heating the food by using the microwave mode, and then entering the cycle stage; wherein microwaves generated by the microwave component penetrate a bottom and/or a side part of a container to reach the inside of the food.

14. The microwave oven control method according to claim 13, where the step of heating food by using the microwave mode comprises:
heating the food by the microwave component at a rated power, and entering the cycle stage after heating time reaches first preset duration.

15. The microwave oven control method according to claim 14, further comprising the following step at the cycle stage for heating the food:
stopping the microwave mode and the air-fry mode at the cycle stage when total heating time of the microwave mode and the air-fry mode reaches second preset duration.

16. The microwave oven control method according to claim 15, further comprising the following step at the cycle stage for heating the food:
setting a ratio of the first preset duration to the second preset duration to be within a range of 1/10 to 5/1.

17. The microwave oven control method according to claim 10, wherein the step of alternately using the microwave mode and the air-fry mode comprises:
making use time of the microwave mode be not greater than use time of the air-fry mode.

18. The microwave oven control method according to claim 17, wherein the step of alternately using the microwave mode and the air-fry mode further comprises:
setting a ratio of the use time of the microwave mode to the use time of the air-fry mode to be within a range of 1/7 to 6/7.
